(19) United States
(12) Patent Application Publication
(10) Pub. No.: US 2019/0066120 A1
(43) Pub. Date: Feb. 28, 2019

(54) SYSTEMS AND METHODS FOR MULTILEVEL ANONYMOUS TRANSACTION COMPLIANCE EVALUATION

(71) Applicant: Walmart Apollo, LLC, Bentonville, AR (US)

(72) Inventors: Rida E. Moustafa, Bentonville, AR (US); Kishore P. Sasthiri, Rogers, AR (US); Jeffrey B. Layton, Bella Vista, AR (US)

(21) Appl. No.: 16/108,826

(22) Filed: Aug. 22, 2018

Related U.S. Application Data
(60) Provisional application No. 62/549,285, filed on Aug. 23, 2017.

(51) Int. Cl. G06Q 30/00; G06Q 20/38; G06Q 30/02; G06F 17/30

(52) U.S. Cl. CPC G06Q 30/018; G06Q 20/383; G06F 17/30241; G06F 17/30994; G06Q 30/0282

(57) ABSTRACT

Systems and methods for transaction compliance evaluation are disclosed. Embodiments can provide rating based on the likelihood of non-compliant transactions at store sites and markets. Embodiments can gather transaction data from retail sites across a region and provide ratings based on a ratio of untraceable transactions above a value threshold. A scaled value is calculated for each transaction based on received market weighting factors and the monetary value of the transaction. The value threshold is selected based on a received cutoff percentage parameter. Site and market ratings are determined based on the number of transactions at each site above or below the value threshold.

### RELATED APPLICATION

The present application claims the benefit of U.S. Provisional Application No. 62/549,285 filed Aug. 23, 2017, which is hereby incorporated herein in its entirety by reference.

### TECHNICAL FIELD

Embodiments of the present disclosure relate generally to the field of retail analytics, in particular to analytical systems for ensuring transaction compliance.

### BACKGROUND

Retail transactions involving untraceable mediums of exchange, such as cash or cash equivalents like gift cards, gift certificates, or money orders, can be used to convert inappropriately obtained funds to tangible goods or services. This can result in retailers unwittingly receiving the proceeds of unlawful activities. In order to lower the likelihood of allowing these transactions, and to comply with relevant anti-money laundering laws and regulations, retailers and other businesses must often restrict the use of untraceable payment methods for certain retail sites, markets, or individuals.

Preventing untraceable transactions outright is generally undesirable for retailers, especially in regions and markets where traceable payment methods such as credit cards, debit cards, or checks may not be generally available to consumers. In addition, instituting maximum monetary values for untraceable transactions can be difficult, based on economic factors that vary between countries, markets, or regions. It is also desirable for retailers to target monitoring and mitigation efforts at individual stores (or retail sites) or markets within a region that present the greatest likelihood of non-compliant untraceable transactions.

What are needed in the industry are systems and methods to assist in rating the likelihood of non-compliant transactions at retail sites and markets internationally.

### SUMMARY

Embodiments of the present disclosure address the need for systems and methods for rating the likelihood of non-compliant transactions at store sites and markets internationally. Embodiments can gather transaction data from retail sites across a region, and provide ratings for retail sites and markets based on the ratio of untraceable transactions above a threshold value, which itself can be analytically determined based on user input and actual transaction data.

In embodiments, a system for dynamically determining a monetary value threshold for evaluating compliance of untraceable transactions at retail sites within a region comprises one or more transaction data providers, each remote from an operably coupled to a plurality of transaction processing systems. The transaction data providers receive transaction data of a plurality of untraceable transaction within the region from the transaction processing systems. The transaction data providers are configured to provided the monetary value of each of the plurality of untraceable transactions.

A transaction remodeler is configured to receive one or more market weighting factors (such as exchange rate data, or cost of living adjustment factors), and determine a plurality of scaled values, each based on the monetary value of one of the untraceable transactions and the one or more market weighting factors.

A threshold calculator can receive a cutoff percentage parameter, and store a value threshold for the region. The value threshold can be selected such that the percentage of transactions within the region with a scaled value below the value threshold is equal to the cutoff percentage parameter.

A site rater can determine a for a retail site within the region based on a ratio of the number of untraceable transactions with a scaled value above the value threshold to a number of untraceable transaction with a scaled value below the value threshold. The rating can be stored in a rating data store such that the rating can be retrieved based on an identifier of the retail site. In embodiments, a market rater can determine a market rating based on the number of retail sites in the market with a high rating.

The rating can be selected from the group consisting of high, medium, and low. In embodiments, the rating is determined to be low if the ratio is equal to or less than 1.25, the rating is determined to be medium if the ratio is above 1.25 and below 2, and the rating is determined to be high if the ratio is equal to or greater than 2.

In embodiments, a transaction evaluator can be operably coupled to a point of sale system at a retail site and a transaction processing system. The transaction evaluator can receive the monetary value of a pending untraceable transaction, determine a maximum transaction value for the retail site based on the rating of the retail site such that the maximum transaction value is lower for a retail site with a high rating than for a retail site with a low rating, and instruct the point of sale system to reject the pending untraceable transaction if the monetary value is higher than the maximum transaction value for the retail site.

In embodiments, a data visualizer can define a map view, with each market or retail site within the map view identified by a marker that is indicative of the rating.

In an embodiment, a method for dynamically determining a monetary value threshold evaluating compliance of untraceable transactions at retail sites within a region can comprise receiving transaction data comprising a monetary value of a plurality of untraceable transactions within a region and one or more market weighting factors. A plurality of scaled values can be determined based on the monetary value of the untraceable transactions and the market weighting factors. A value threshold for the region can be stored, the value threshold can be chosen such that the percentage of transactions within the region with a scaled value below the value threshold is equal to a received cutoff percentage parameter. A rating for a retail site within the region can be determined based on the ratio of the number of untraceable transactions with a scaled value above the value threshold to a number of untraceable transactions with a scaled value below the value threshold. The rating can be stored in a data store such that it can be retrieved based on an identifier of the retail site.

In embodiments, the method can further comprise receiving the value of a pending untraceable transaction from a point of sale system at a retail site, determining a maximum transaction value for the retail site based on the rating of the retail site and instruction the point of sale system to reject the pending untraceable transaction if the value is higher than the maximum transaction value for the retail site. The maximum transaction value is lower for a retail site with a high rating than for a retail site with a low rating.

In embodiments, the method can further include storing a plurality of renderable structures defining a graphical display of a map view comprising a retail site marker (including an indication of the rating of the retail site) for each retail site within the map view.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures.

FIG. 1 is a schematic diagram depicting retail sites and data flow within a region, according to an embodiment.

FIG. 2 is a block diagram depicting data elements of a transaction data record, according to an embodiment.

FIG. 3 is a block diagram depicting components of a compliance evaluation system, according to an embodiment.

FIG. 4A is a graph depicting example transaction data, according to an embodiment.

FIG. 4B is a chart depicting example transaction data, according to an embodiment.

FIG. 4C is a screenshot depicting an example map view, according to an embodiment.

FIG. 4D is a screenshot depicting an example map view, according to an embodiment.

FIG. 5 is a flowchart depicting a method for determining ratings, according to an embodiment.

FIG. 6A is a data table depicting portions of example transaction data records, according to an embodiment.

FIG. 6B is a data table depicting portions of example transaction data records, according to an embodiment.

FIG. 6C is a data table depicting example site ratings, according to an embodiment.

FIG. 7 is a flowchart depicting a method for evaluating a pending transaction, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION OF THE DRAWINGS

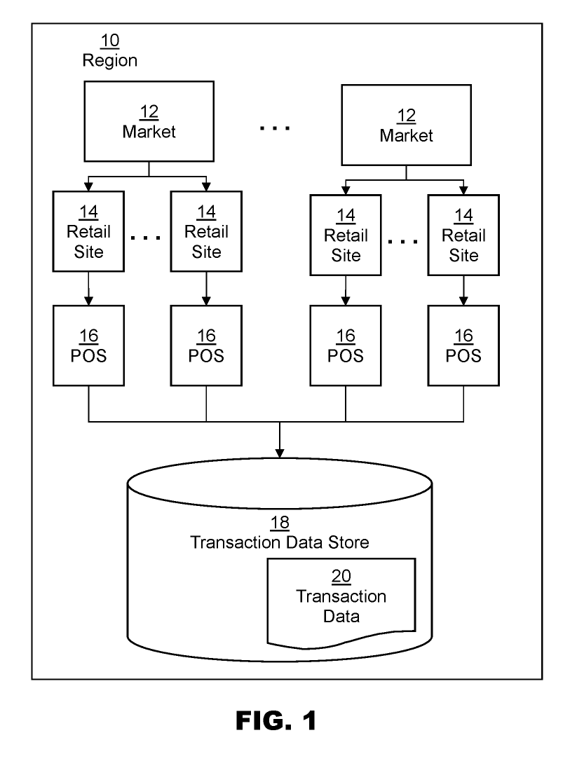

FIG. 1 is a schematic diagram depicting a transaction data flow as might be maintained by a large retail organization. A geographical region 10 (such as a city, state, country, county, municipal district or other defined area) can have a plurality of markets 12 and retail sites 14. Though each retail site 14 is depicted as belonging to a single market 12, each retail site 14 can belong to a plurality of markets. Each retail site 14 can have a number of transaction processing systems 16. Transaction processing systems 16 can comprise point-of-sale (POS) systems such as cash registers, or transaction aggregation servers. Transaction aggregation servers can be configure to communicate, over an internal network at a retail site, with individual point-of-sale systems to receive transaction data. Transaction processing system 16 can be in continuous or intermittent data communication with transaction data store 18 over a network in order to provide transaction data records 20 for each retail transaction.

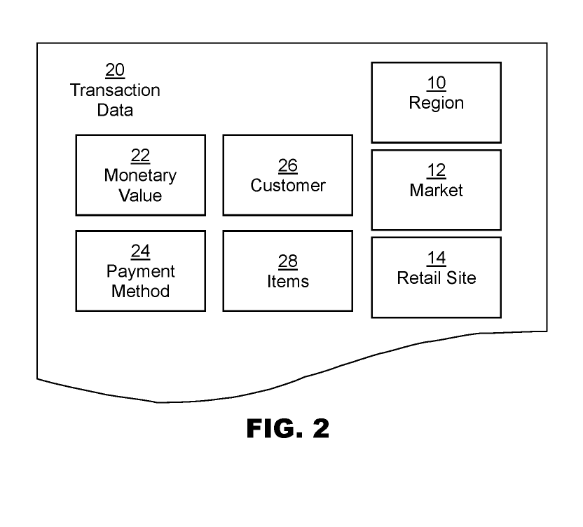

FIG. 2 is a block diagram depicting data elements of a transaction data record 20, according to an embodiment. Each transaction data record 20 can include the monetary value 22 and the payment method 24 (such as cash, gift card, check, credit or debit card, or the like) for each transaction. Transaction data records 20 can further include links to, or be otherwise associated with, the retail site 14, market 12 and/or region 10 where the transaction took place, customer information 26 (if available), and an indication of the items 28, which can be goods or services involved in the transaction. Transaction data store 18 can reside within a single database system, or can comprise a distributed file system, or other storage mechanisms such that transaction data store 18 resides across multiple computing systems.

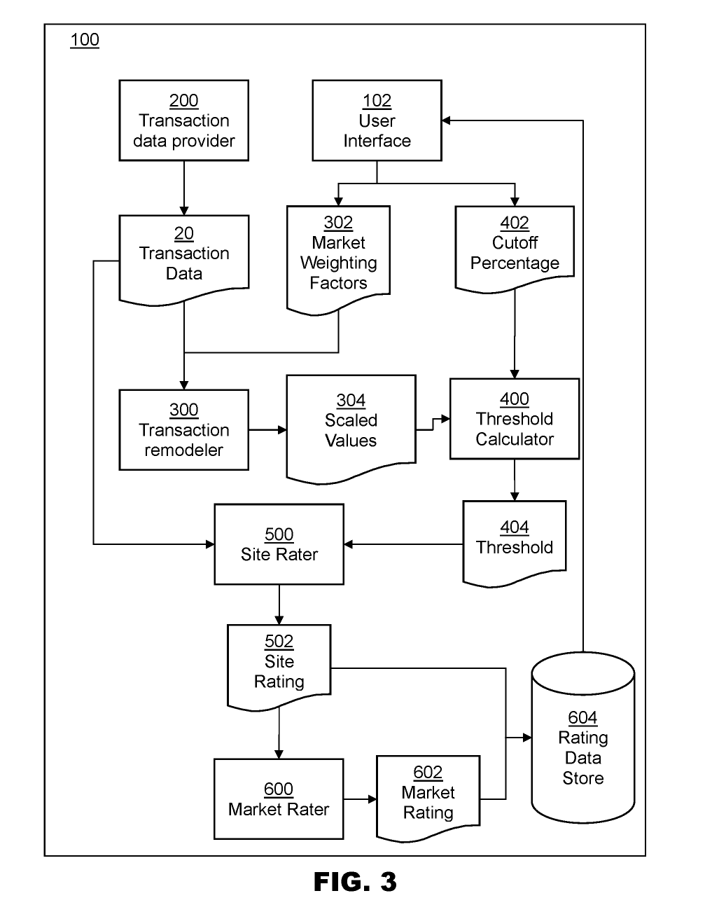

FIG. 3 is a schematic diagram depicting components and engines of a compliance evaluation system 100. In embodiments, compliance evaluation system 100 can comprise user interface 102, a transaction data provider 200 in data communication with transaction data store 18, a transaction remodeler 300, a threshold calculator 400, and a site rater 500.

The various components and engines of system 100 can reside on, or be executed by, a single computing device in embodiments. In other embodiments, the components and engines of system 100 can reside on, or by executed by, a plurality of computing devices in continuous or intermittent, wired or wireless, data communication with each other such that the systems and methods described herein can be executed in parallel.

User interface 102 can be a command line interface, a graphical user interface, a web browser accessible interface, an augmented reality interface, or any other interface that can receive user input and present outputs of system 100 to the user. In an embodiment, user interface 102 can be a programmatic interface, such that the user can be a computing system, robot, or other electronic device.

Transaction data provider 200 can provide transaction data records 20 for transactions using untraceable payment methods, such as cash, or cash equivalents. In some embodiments, transaction data provider 200 can query transaction data store 18 to retrieve transaction data 20 as needed. In other embodiments, transaction data provider 200 can store a mirror or copy of the relevant data. Transaction data records 20 can be refreshed at regular intervals, such as hourly or daily, or can be refreshed based on requests from a user. In embodiments, transaction data records 20 can be grouped by customer and visit, such that multiple transactions involving a single customer are provided a single transaction data record 20.

Transaction remodeler 300 can receive one or more market weighting factors 302 and calculate a scaled value 304 for each transaction data record 20 provided by transaction data provider 200. Market weighting factors 302 can comprise an exchange rate between the currency of the transaction and a standard currency. Market weighting factors 302 can further comprise a cost of living adjustment factor. Market weighting factors 302 can therefore enable calculation of scaled values 304 that are normalized across currencies and/or other economic factors within region 10.

Scaled values 304 can be calculated by multiplying monetary values 22 by each of the one or more market weighting factors 302. In embodiments, market weighting factors 302 can themselves be weighted, such that a scaled value 304 can be more influenced by one market weighting factor than another. In an embodiment, a scaled value 304 can be calculated using the formula below, or another formula or calculation method known in the art:

SV=MV×(f₁w₁× . . . ×fᵢwᵢ)

where SV is a scaled value 304, MV is a monetary value 22, fᵢ are market weighting factors 302, and wᵢ are relative weights of each market weighting factor 302.

Threshold calculator 400 can receive a user-configurable cutoff percentage parameter 402, and determine a scaled value threshold 404 for region 10 such that the percentage of transaction data records 20 within the region with a scaled value 304 below the value threshold 404 is equal to the cutoff percentage parameter 402. Cutoff percentage parameter 402 can be determined based on government regulations or business rules. In one embodiment, value threshold 404 can be determined by multiple cutoff percentage parameters 402 to determine the number of cutoff transactions (N), sorting the transaction data records 20 within the region 10 by the monetary value 22, and choosing the value threshold to be the monetary value 22 of the N+1th sorted transaction data record 20, though other methods can be used.

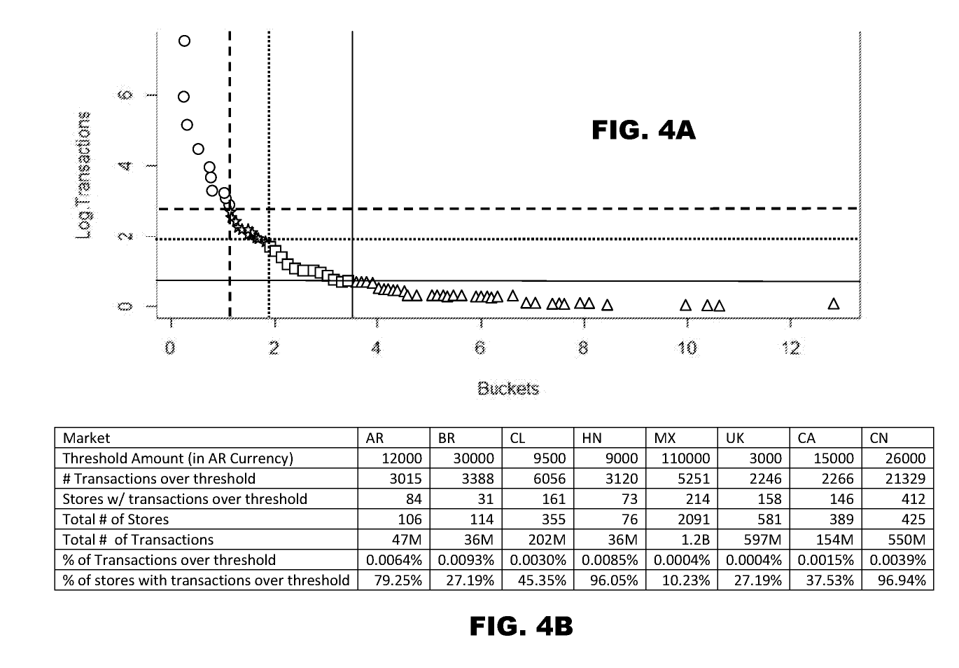

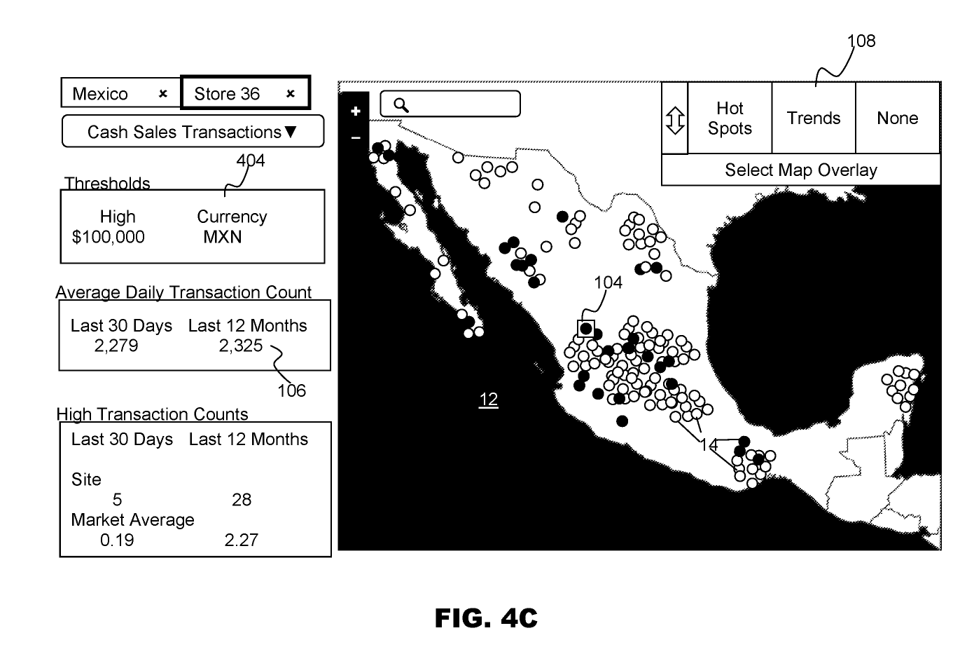

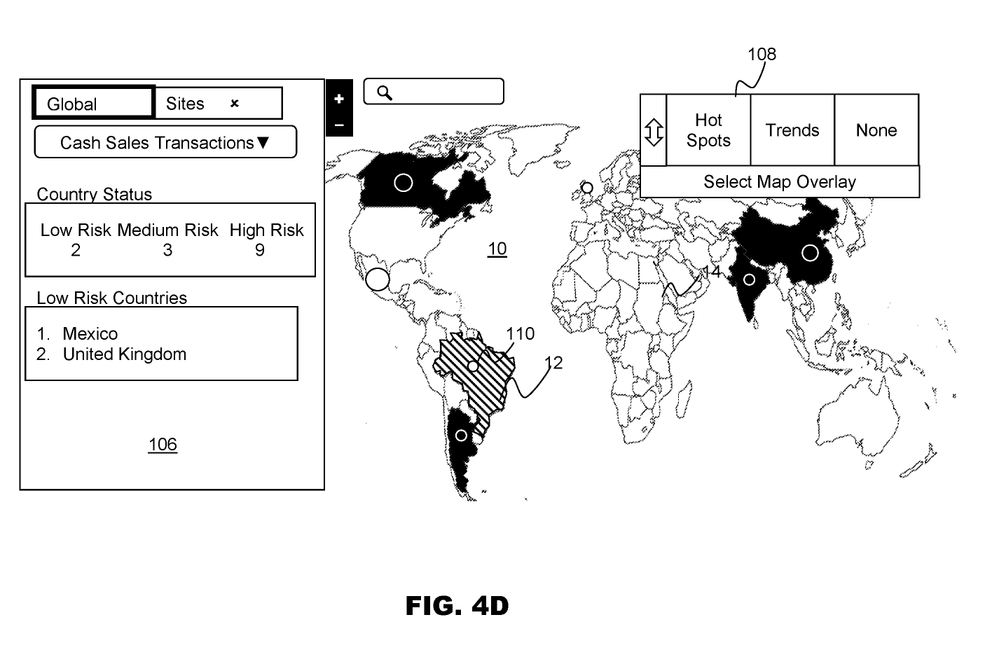

In embodiments, user interface 102 can present one or more aggregated views of transaction data records 20 in order to assist the user in determining a cutoff percentage parameter 402. FIG. 4A is a graph depicting example transaction data records 20 aggregated into buckets of thousands of monetary units based on scaled values 304. As depicted, the x-axis represents each bucket, and the y-axis represents the decimal logarithm of the number of transactions that fall into each bucket. Those of ordinary skill in the art will appreciate that this distribution can be approximated by a Chi-Square distribution with four degrees of freedom. Aggregating and presenting the data in this format can enable the user to leverage the properties of the Chi-Square distribution for detection of outlier values and anomalies. Other distributions, for example heavy-tailed distributions, can also be used as desired based on transaction data records 20.

FIG. 4B is a chart depicting an alternative example view of aggregated transaction data records 20. In the depicted example, the value threshold 404 for each of a number of markets 12 has been calculated. The number and percentages of transactions above the threshold are displayed, as with the number and percentages of stores with transactions above the threshold. Those of ordinary skill in the art will appreciate that other aggregated data elements can be provided as necessary.

In embodiments, aggregated views such as those depicted in FIGS. 4A and 4B can be generated automatically based on updated transaction data records 20, or manually requested. In one embodiment, data aggregation can be generated by statistical visualization tools and/or languages such as R, Eclipse Business Intelligence and Reporting Tools (BIRT), or the like.

Given a single cutoff percentage parameter 402 for a region, value thresholds 404 can be determined analytically based on actual transaction data. As opposed to ad-hoc methods, value thresholds 404 can be updated dynamically as new transaction data is available. In addition, because value thresholds 404 are based on scaled values 304, differences in economic factors such as cost of living and exchange rate are automatically accounted for, essentially normalizing value thresholds 404 across markets.

Returning now to FIG. 3, site rater 500 can calculate a site rating 502 indicative of the likelihood of non-compliant transactions for each retail site 14 with region 10. Site rating 502 can be calculated based on the ratio of the number of untraceable transactions with scaled values over the value threshold 404 to the total number of untraceable transactions:

$$\frac{\begin{matrix}number of untraceable transactions with scaled \\ values exceeding the value threshold\end{matrix}}{total number of untraceable transactions}$$

In embodiments, a ratio below 1.25 can be given a low rating, a ratio between 1.25 and 2 can be given a medium rating, and a ratio above 2 can be given a high rating, though other ratios or groupings can be used. Site ratings 502 can enable a retailer to focus resources towards maintaining transaction compliance at the stores having the great likelihood of non-compliant transactions due to illegal activity such as money laundering. For example, retail sites 14 with high ratings can have lower maximum transaction limits, or untraceable transactions can be forbidden completely.

In embodiments, market rater 600 can calculate a market rating 602, indicative of the likelihood of non-compliant transactions within a market 12 based on the site rating 502 for each retail site 14 with the market 12. In an embodiment, a market rating 602 can be low if fewer than four retail sites 14 have a high rating, medium if four to eight stores have a high rating, and high if more than about eight sites have a high rating, though other values can be used.

Site ratings 502 and market ratings 602 can be presented to the user via user interface 102. In an embodiment, user interface 102 can comprise a map view of all or part of region 10, in which each retail site 14 and/or market 12 is represented by a marker or other indicator that is color-coded based on the rating such that a low rating is green, a medium rating is yellow, and a high rating is red, though of course other colors can be used.

In embodiments, site ratings 502 and market ratings 602 can be provided in a geographic annotation format readable by map visualization tools, such as Geography Markup Language (GML) or Keyhole Markup Language (KML) files for integration with external mapping systems.

FIG. 4C is a screenshot depicting an example map view displaying site ratings 502 for a market 12, in this case a single country: Mexico. Retail sites 14 are displayed with markers according to the site rating 502 (for example, light and dark markers). A selected site 104 can be highlighted, and further details regarding the selected site 104 can be displayed in information bar 106. Information bar 106 can comprise a display of the current value threshold 404 (and corresponding currency). Information bar 106 can further comprise aggregate transaction data for various time periods (such as the previous 30 days, or 12 months) for the selected site 104, including the average and/or total number of transactions, and “high” transactions that were over the value threshold 404. An average for the whole market 12 can also be provided for comparison purposes. Overlay bar 108 can enable the user to add layers including other data such a demographic, weather, or any other geographic annotation data.

FIG. 4D is a screenshot depicting an example map view displaying market ratings 602 for a region 10 encompassing the entire globe. Markets 12 can be displayed with shading based on the market rating 602. Information bar 106 can display the number of markets 12, or countries in each rating category, and provide a list of countries in a selected category. Markets 12 can also be depicted with indicators 110, that are sized and colored based on market data such as demographic data, or the number of retail sites per capita.

In embodiments, user interface 102 can enable the user to perform map viewing functions such as zooming in and/or out, or panning around within map views such as those depicted in 4C and 4D. User interface 102 can further enable the user to drill up and/or down in order to view rating data from a world, regional, market, site, municipality, or other level. For example, clicking on the country of Mexico in FIG. 4D can result in user interface 102 generating the map view of FIG. 4C, in embodiments.

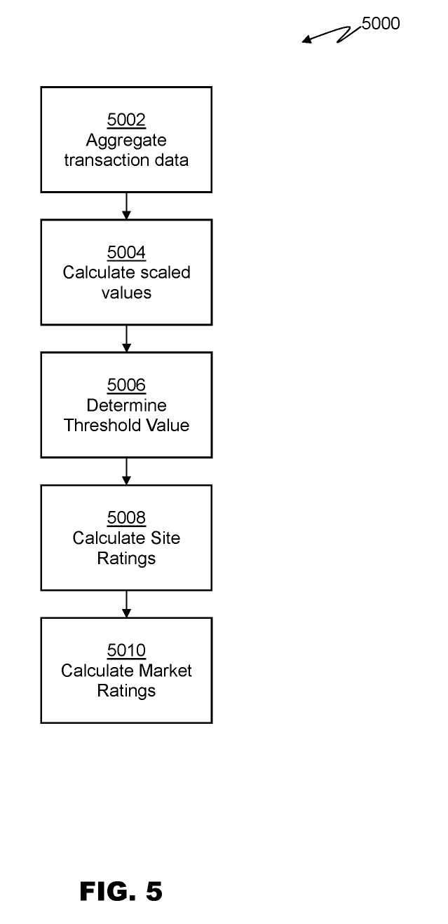

In operation, the various components and engines of compliance evaluation system 100 can provide site ratings 502 and market ratings 602 for retail sites and markets within a region via execution of method 5000 as depicted in FIG. 5.

At 5002, transaction data records can be aggregated. In embodiments, transaction data records 20 can be organized into groups based on the monetary value 22 of each transaction data record.

At 5004, scaled values 304 can be calculated based on market weighting factors 302. In embodiments, market weighting factors 302 can be entered for each execution of method 5000, or market weighting factors 302 can be retrieved based on previously stored values.

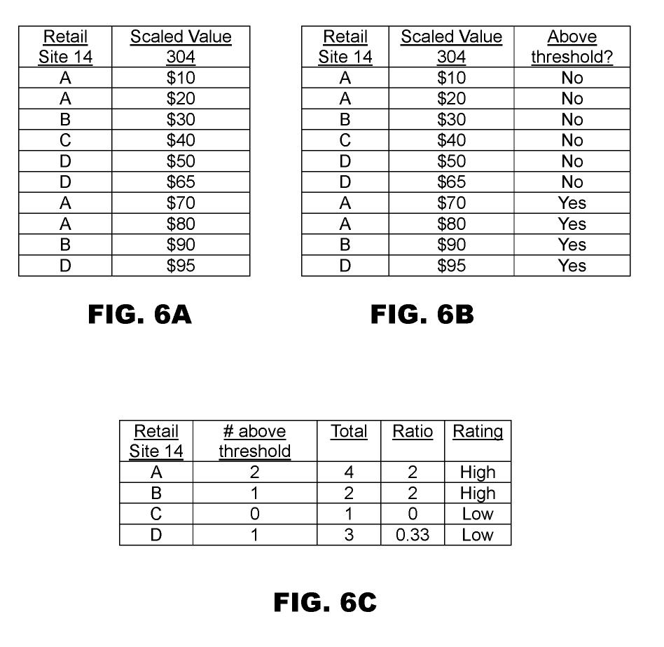

At 5006, threshold values 404 can be calculated based on scaled values 304 and cutoff percentage parameter 402. In embodiments, cutoff percentage parameter 402 can be entered for each execution of method 5000 or cutoff percentage parameter 402 can be retrieved based on previously stored values. FIG. 6A is a data table presenting example scaled values 304 at four retail sites 14 (A through D). If the cut-off percentage parameter 402 is set to 60%, for example, a threshold of $66 would be appropriate as 60% of the transactions have a value below the threshold.

Returning now to FIG. 5, at 5008, site ratings 502 can be calculated, and at 5010, market ratings can be calculated. Calculation of site ratings 502 can be seen in FIGS. 6B and 6C, which are based on the example of FIG. 6A, discussed above. Given a threshold value of $66, each transaction can be determined to be above or below the threshold, as depicting the table of FIG. 6B. FIG. 6C depicts the results of determining the ratio of total transactions to transactions over the threshold. Here, both retail sites A and B receive a “high” rating, due to the number of transactions above the threshold value.

In operation, method 5000 can be executed on demand. In embodiments, the various tasks of method 5000 can be executed dynamically based on real-time, or near real-time updates to transaction data records 20. For example, transaction data records 20 can be updated from the various retail sites 14 on an hourly basis, or as new transactions are processed at retail sites 14. Embodiments of system 100 and method 5000 can be executed in response to the regularly scheduled data update which can provide up-to-date information regarding transaction compliance risk across the region.

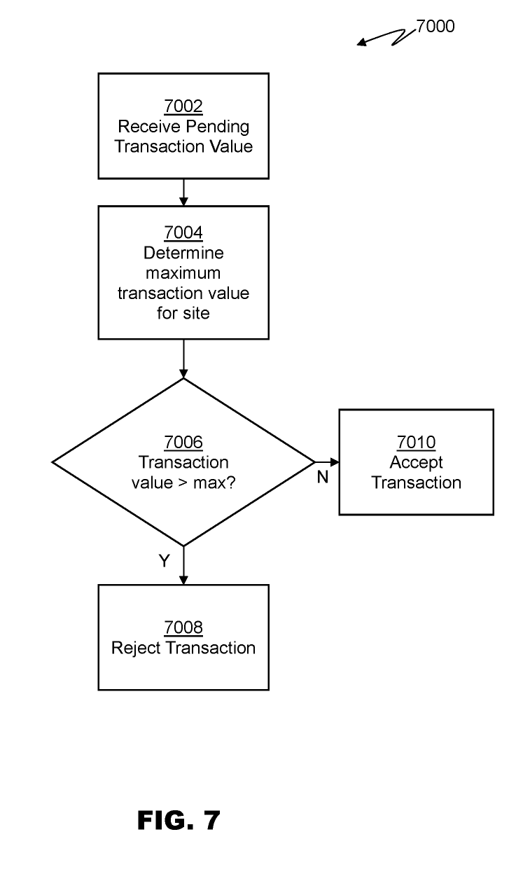

In an embodiment, a transaction evaluator (not shown) can be operably coupled to a point of sale system at a retail site 14 and transaction data store 18. FIG. 7 is a flowchart depicting a method for determining if a transaction should be rejected based on the transaction value and the risk rating of the retail site. At 7002, the value of the pending transaction is received. At 7004, a maximum transaction value is chosen. The maximum transaction value can be user-configurable, or determined by the system such that the maximum transaction value is lower for a retail site with a high risk rating than for a retail site with a low risk rating.

At 7006, the pending transaction can be compared to the maximum transaction value. If the pending value is greater than the maximum value, the transaction can be rejected at 7008. A rejected transaction can allow an associate at a retail sales site to request a different payment method, or additional identifying information from the customer. If the pending value is lower than the maximum value, the transaction can be accepted at 7010.

It should be understood that the individual steps used in the methods of the present teachings may be performed in any order and/or simultaneously, as long as the teaching remains operable. Furthermore, it should be understood that the apparatus and methods of the present teachings can include any number, or all, of the described embodiments, as long as the teaching remains operable. In addition, numerical comparisons in the described embodiments can comprise the inverse comparison, and less strict comparisons (less than can also be less than or equal to) in embodiments.

In one embodiment, the system 100 and/or its components or subsystems can include computing devices, microprocessors, modules and other computer or computing devices, which can be any programmable device that accepts digital data as input, is configured to process the input according to instructions or algorithms, and provides results as outputs. In one embodiment, computing and other such devices discussed herein can be, comprise, contain or be coupled to a central processing unit (CPU) configured to carry out the instructions of a computer program. Computing and other such devices discussed herein are therefore configured to perform basic arithmetical, logical, and input/output operations.

Computing and other devices discussed herein can include memory. Memory can comprise volatile or non-volatile memory as required by the coupled computing device or processor to not only provide space to execute the instructions or algorithms, but to provide the space to store the instructions themselves. In one embodiment, volatile memory can include random access memory (RAM), dynamic random access memory (DRAM), or static random access memory (SRAM), for example. In one embodiment, non-volatile memory can include read-only memory, flash memory, ferroelectric RAM, hard disk, floppy disk, magnetic tape, or optical disc storage, for example. The foregoing lists in no way limit the type of memory that can be used, as these embodiments are given only by way of example and are not intended to limit the scope of the disclosure.

In one embodiment, the system or components thereof can comprise or include various modules or engines, each of which is constructed, programmed, configured, or otherwise adapted to autonomously carry out a function or set of functions. The term “engine” as used herein is defined as a real-world device, component, or arrangement of components implemented using hardware, such as by an application specific integrated circuit (ASIC) or field-10 programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engine, each of which can be regarded as an engine in its own right. Moreover, in the embodiments described herein, each of the various engines corresponds to a defined autonomous functionality; however, it should be understood that in other contemplated embodiments, each functionality can be distributed to more than one engine. Likewise, in other contemplated embodiments, multiple defined functionalities may be implemented by a single engine that performs those multiple functions, possibly alongside other functions, or distributed differently among a set of engines than specifically illustrated in the examples herein.

Various embodiments of systems, devices, and methods have been described herein. These embodiments are given only by way of example and are not intended to limit the scope of the claimed inventions. It should be appreciated, moreover, that the various features of the embodiments that have been described may be combined in various ways to produce numerous additional embodiments. Moreover, while various materials, dimensions, shapes, configurations and locations, etc. have been described for use with disclosed embodiments, others besides those disclosed may be utilized without exceeding the scope of the claimed inventions.

Persons of ordinary skill in the relevant arts will recognize that embodiments may comprise fewer features than illustrated in any individual embodiment described above. The embodiments described herein are not meant to be an exhaustive presentation of the ways in which the various features may be combined. Accordingly, the embodiments are not mutually exclusive combinations of features; rather, embodiments can comprise a combination of different individual features selected from different individual embodiments, as understood by persons of ordinary skill in the art. Moreover, elements described with respect to one embodiment can be implemented in other embodiments even when not described in such embodiments unless otherwise noted. Although a dependent claim may refer in the claims to a specific combination with one or more other claims, other embodiments can also include a combination of the dependent claim with the subject matter of each other dependent claim or a combination of one or more features with other dependent or independent claims. Such combinations are proposed herein unless it is stated that a specific combination is not intended. Furthermore, it is intended also to include features of a claim in any other independent claim even if this claim is not directly made dependent to the independent claim.

Moreover, reference in the specification to “one embodiment,” “an embodiment,” or “some embodiments” means that a particular feature, structure, or characteristic, described in connection with the embodiment, is included in at least one embodiment of the teaching. The appearances of the phrase “in one embodiment” in various places in the specification are not necessarily all referring to the same embodiment.

Any incorporation by reference of documents above is limited such that no subject matter is incorporated that is contrary to the explicit disclosure herein. Any incorporation by reference of documents above is further limited such that no claims included in the documents are incorporated by reference herein. Any incorporation by reference of documents above is yet further limited such that any definitions provided in the documents are not incorporated by reference herein unless expressly included herein.

For purposes of interpreting the claims, it is expressly intended that the provisions of Section 112, sixth paragraph of 35 U.S.C. are not to be invoked unless the specific terms “means for” or “step for” are recited in a claim.

What is claimed is:

1. A system for dynamically determining a monetary value threshold for evaluating compliance of untraceable transactions at retail sites within a region, the system comprising:
one or more transaction data providers, remote from and operably coupled to a plurality of transaction processing systems to receive transaction data of a plurality of untraceable transactions within the region from the transaction processing systems, and configured to provide the monetary value of each of the plurality of untraceable transactions;
a transaction remodeler configured to:
receive one or more market weighting factors, and
determine a plurality of scaled values each based on the monetary value of one of the plurality of untraceable transactions and the one or more market weighting factors;
a threshold calculator configured to:
receive a cutoff percentage parameter, and
store a value threshold for the region such that a percentage of transactions within the region with a scaled value below the value threshold is equal to the cutoff percentage parameter; and
a site rater configured to:
determine a rating for a retail site within the region based on a ratio of a number of untraceable transactions with a scaled value above the value threshold to a number of untraceable transactions with a scaled value below the value threshold, and
store the rating in a rating data store such that the rating can be retrieved based on an identifier of the retail site.

2. The system of claim 1, wherein the rating is selected from the group consisting of: high, medium, and low.

3. The system of claim 2, wherein the rating is determined to be low if the ratio is equal to or less than 1.25, the rating is determined to be medium if the ratio is above 1.25 and below 2, and the rating is determined to be high if the ratio is equal to or greater than 2.

4. The system of claim 2, further comprising a transaction evaluator operably coupled to a point of sale system at a retail site and a transaction processing system and configured to:
receive the monetary value of a pending untraceable transaction,
determine a maximum transaction value for the retail site based on the rating of the retail site such that the maximum transaction value is lower for a retail site with a high rating than for a retail site with a low rating, and
instruct the point of sale system to reject the pending untraceable transaction if the monetary value is higher than the maximum transaction value for the retail site.

5. The system of claim 2, further comprising a market rater configured to determine a market rating based on a number of retail sites in the market with a high rating.

6. The system of claim 1, wherein at least one of the one or more transaction data providers comprises a data aggregator configured to receive transaction data from a plurality of retail sites.

7. The system of claim 1, wherein at least one of the market weighting factors is an exchange rate.

8. The system of claim 1, wherein at least one of the market weighting factors is a cost of living adjustment factor.

9. The system of claim 1, further comprising a data visualizer configured to store a plurality of renderable structures defining a graphical display of a map view comprising a retail site marker for each retail site within the map view, each retail site marker including an indication of the rating of the retail site.

10. A method for dynamically determining a monetary value threshold evaluating compliance of untraceable transactions at retail sites within a region, the method comprising:
receiving transaction data comprising a monetary value of a plurality of untraceable transactions within the region;
receiving one or more market weighting factors;
determining a plurality of scaled values each based on the monetary value of one of the plurality of untraceable transactions and the one or more market weighting factors;
receiving a cutoff percentage parameter;
storing a value threshold for the region such that a percentage of transactions within the region with a scaled value below the value threshold is equal to the cutoff percentage parameter;
determining a rating for a retail site within the region based on a ratio of a number of untraceable transactions with a scaled value above the value threshold to a number of untraceable transactions with a scaled value below the value threshold; and
storing the rating in a rating data store such that the rating can be retrieved based on an identifier of the retail site.

11. The method of claim 10, wherein the rating is selected from the group consisting of: high, medium, and low.

12. The method of claim 11, wherein the rating is determined to be low if the ratio is equal to or less than 1.25, the rating is determined to be medium if the ratio is above 1.25 and below 2, and the rating is determined to be high if the ratio is equal to or greater than 2.

13. The method of claim 11, further comprising:
receiving the value of a pending untraceable transaction from a point of sale system at a retail site;
determining a maximum transaction value for the retail site based on the rating of the retail site such that the maximum transaction value is lower for a retail site with a high rating than for a retail site with a low rating; and
instructing the point of sale system to reject the pending untraceable transaction if the value is higher than the maximum transaction value for the retail site.

14. The method of claim 11, further comprising determining a rating for a market based on a number of retail sites in the market with a high rating.

15. The method of claim 10, wherein the plurality of untraceable transactions is received from a plurality of retail sites.

16. The method of claim 10, wherein at least one of the market weighting factors is an exchange rate.

17. The method of claim 10, wherein at least one of the market weighting factors is a cost of living adjustment factor.

18. The method of claim 10, further comprising storing a plurality of renderable structures defining a graphical display of a map view comprising a retail site marker for each retail site within the map view, each retail site marker including an indication of the rating of the retail site.
